(19) United States
(12) Patent Application Publication
(10) Pub. No.: US 2026/0037797 A1
(43) Pub. Date: Feb. 5, 2026

(54) METHODS AND SYSTEMS FOR IDENTIFYING, AVOIDING, OR REDUCING HALLUCINATIONS OR OTHER INACCURACIES IN GENERATIVE ARTIFICIAL INTELLIGENCE OUTPUT

(71) Applicant: BrandRank.AI Inc., Cincinnati, OH (US)

(72) Inventors: Joseph Henry HUDEPOHL, Fort Mitchell, KY (US); Matthew Adam COX, Newton, MA (US); Kelly COHEN, Mason, OH (US)

(21) Appl. No.: 19/061,063

(22) Filed: Feb. 24, 2025

Related U.S. Application Data
(60) Provisional application No. 63/679,574, filed on Aug. 5, 2024.

(51) Int. Cl. G06N 3/08; G06N 3/0475

(52) U.S. Cl. CPC G06N 3/08; G06N 3/0475

(57) ABSTRACT

Methods, systems, and computer program products that address inaccuracies in generative artificial intelligence (Gen AI) output. Some implementations involve identifying hallucinations, e.g., identifying circumstances in which differences between Gen AI output and a source of truth are greater than an acceptable threshold. Some implementations identify hallucinations and other inaccuracies using a set-based comparison technique that quantifies or otherwise measures accuracy based on similarity to a known source of truth. Some implementations enable the filtering of hallucinations and other inaccuracies in Gen AI (e.g., LLM) outputs. Some implementations enable such identification and/or filtering of Gen AI output by utilizing predetermined or customizable accuracy and/or confidence thresholds. A variety of post-comparison actions may be initiated based on identifying and/or filtering Gen AI output inaccuracies.

### CROSS-REFERENCE TO RELATED APPLICATIONS

This application claims the benefit of U.S. Provisional Application Ser. No. 63/679,574 filed Aug. 5, 2024, entitled “Method and System for Filtering Hallucinations in Large Language Model Outputs,” which is incorporated herein in its entirety.

### TECHNICAL FIELD

The present invention generally relates to artificial intelligence (AI) and machine learning, and more specifically, to methods, systems, and computer program products for assessing and addressing inaccuracies in generative artificial intelligence (Gen AI) output.

### BACKGROUND

Large language model (LLM) and other Gen AI systems often produce output results that include hallucinations (i.e., responses that are plausible but factually incorrect or misleading) or other factual inaccuracies relative to a source of truth (e.g., a dataset that is considered as including factual accurate information). In many circumstances, it is desirable to assess, identify, avoid, or reduce such inaccuracies. There is a need for methods and systems that can verify accuracy, improve accuracy, and/or otherwise better account for such inaccuracies to ensure the reliability and trustworthiness of AI-generated content.

### SUMMARY

Implementations disclosed herein provide methods, systems, and computer program products that address inaccuracies in generative artificial intelligence (Gen AI) output. Some implementations involve identifying hallucinations, e.g., identifying circumstances in which differences between Gen AI output and a source of truth are greater than an acceptable threshold. Some implementations identify hallucinations and other inaccuracies using a set-based comparison technique that quantifies or otherwise measures accuracy based on similarity to a known source of truth. Some implementations enable the filtering of hallucinations and other inaccuracies in Gen AI (e.g., LLM) outputs. Some implementations enable such identification and/or filtering of Gen AI output by utilizing predetermined or customizable accuracy and/or confidence thresholds. A variety of post-comparison actions may be initiated based on identifying and/or filtering Gen AI output inaccuracies.

In some implementations, a processor performs a method by executing instructions stored on a computer readable medium. The method may be used to verify or improve accuracy of Gen AI model output. The method involves identifying a context-specific data set comprising factual information associated with a context. In one exemplary use case, the context is specific to an organization or other business entity. In another exemplary use case, the context is specific to a particular group. In another exemplary use case, the context is specific to a particular topic within an organization's knowledge set. In another exemplary use case, the context is determined based on a specific query, e.g., the input query used to initiate for the Gen AI model process.

The exemplary method further involves receiving output of the Gen AI model, where the Gen AI model produced the output based on an input query and information from the context-specific data set. The Gen AI model produces outputs with a first level of inaccuracies. In some implementations, this involves a retrieval-augmentation generation (RAG) process in which, for example, a large language model (LLM) receives input that corresponds to an input query and information from the context-specified data set. The Gen AI model may produce output that includes hallucinations and/or other inaccuracies, e.g., results that include (on average or in a given case) a percentage (e.g., 20%) of hallucinations.

The method further involves generating an accuracy score for the output corresponding to the first level of inaccuracies. The accuracy score is generated based on a comparison of the output with the context-specific data set. Such a comparison may involve assessing similarity between groups of one or more words of the output with one or more words of the context-specific data set.

The method may further involve determining that the output fails to satisfy an accuracy criterion based on the accuracy score and, based on determining that the output fails to satisfy the accuracy criterion, initiating an action. The action may be an action to provide a second output to the input query. The action may have an action type. The action may result in producing the second output with a second level of inaccuracies that is less than the first level of inaccuracies.

Alternatively, the method may further involve determining that the output satisfies an accuracy criterion based on the accuracy score and, based on determining that the output satisfies the accuracy criterion, initiating an action to enable the output to be provided in response to the input query.

In accordance with some implementations, a device includes one or more processors, a non-transitory memory, and one or more programs; the one or more programs are stored in the non-transitory memory and configured to be executed by the one or more processors and the one or more programs include instructions for performing or causing performance of any of the methods described herein. In accordance with some implementations, a non-transitory computer readable storage medium has stored therein instructions, which, when executed by one or more processors of a device, cause the device to perform or cause performance of any of the methods described herein. In accordance with some implementations, a device includes: one or more processors, a non-transitory memory, and means for performing or causing performance of any of the methods described herein.

This summary is provided to introduce a selection of concepts in a simplified form that are further described below in the detailed description. This summary is not intended to identify key features or essential features of the claimed subject matter, nor is it intended to be used in isolation as an aid in determining the scope of the claimed subject matter.

### BRIEF DESCRIPTION OF DRAWINGS

The accompanying drawings, which are incorporated in and constitute a part of this specification, illustrate various implementations of the invention and, together with a general description of the invention given above and the detailed description of the implementations given below, serve to explain the implementations of the invention. In the drawings, like reference numerals refer to like features in the various views.

FIG. 1 is a block diagram illustrating exemplary system components of a system configured to assess, identify, filter, or otherwise address hallucinations or other inaccuracies in Gen AI output in accordance with some implementations.

FIG. 2 is a block diagram illustrating exemplary process flow of a system configured to assess, identify, filter, or otherwise address hallucinations or other inaccuracies in Gen AI output in accordance with some implementations.

FIG. 3 is a block diagram illustrating an exemplary method to identify, filter, or otherwise address hallucinations or other inaccuracies in Gen AI output, in accordance with some implementations.

FIG. 4 is a block diagram illustrating an exemplary method to identify, filter, or otherwise address hallucinations or other inaccuracies in Gen AI output, in accordance with some implementations.

FIG. 5 is a block diagram of an example computer architecture for a computer capable of executing software components described herein, according to some implementations described herein.

In accordance with common practice the various features illustrated in the drawings may not be drawn to scale. Accordingly, the dimensions of the various features may be arbitrarily expanded or reduced for clarity. In addition, some of the drawings may not depict all of the components of a given system, method or device. Finally, like reference numerals may be used to denote like features throughout the specification and figures.

### DETAILED DESCRIPTION

Numerous details are described in order to provide a thorough understanding of the example implementations shown in the drawings. However, the drawings merely show some example aspects of the present disclosure and are therefore not to be considered limiting. Those of ordinary skill in the art will appreciate that other effective aspects and/or variants do not include all of the specific details described herein. Moreover, well-known systems, methods, components, devices and circuits have not been described in exhaustive detail so as not to obscure more pertinent aspects of the example implementations described herein.

Implementations disclosed herein provide methods, systems, and computer program products that address inaccuracies in Gen AI output. Some implementations involve identifying hallucinations or other inaccuracies, e.g., identifying circumstances in which differences between Gen AI output and a source of truth are greater than an acceptable threshold. Some implementations confirm when such Gen AI output and a source of truth are within an acceptable threshold. Some implementations enable the filtering of hallucinations and other inaccuracies in Gen AI (e.g., LLM) outputs or other actions to improve the accuracy of the Gen AI output.

Some implementations utilize a comparison against a source of truth data set (e.g., a known set of accurate data, a rule book, standard operation procedures (SOPs), etc.) to verify the authenticity and/or accuracy of Gen AI generated output responses. Gen AI output responses that fail to meet a certain accuracy threshold may be filtered out or flagged for review. The verification process may be integrated into a user interface-based system through which a user interacts with a Gen AI process. By integrating the verification process, the system may enhance the reliability of Gen AI outputs across various applications including, but not limited to, brand monitoring, military operations, and customer service chatbots and other processes. Implementations may reduce risks associated with misinformation and enhance user trust in Gen AI systems.

Some implementations identify a source of context-specific information and guide a Gen AI process to provide results to a use query utilizing the source of information. For example, when an employee user asks (via an input query) about an employer policy, an LLM tasked with providing a response may be given a data set that includes the employer's policy documents. The output of the LLM may then be compared against that source of information to assess its accuracy. Such a comparison may attempt to determine whether the response accurately represents the information available in that source of information. This comparison process may account for output information including multiple pieces of information and/or differences in expression (e.g., that similar or the same concepts may be expressed using different words and phrases). The comparison may involve sequence matching of characters, words, phrases, tokens, etc. in comparison data sets.

Some implementations disclosed herein utilize a set comparison technique to determine a measure of similarity between sets (e.g., a set corresponding to a Gen AI output and a set corresponding to a source of truth dataset or portion thereof). A comparison process may involve identifying the sets for comparison, calculating a union of the sets (e.g., a mathematical union based upon set theory or a concatenation of the sets), performing non-linear mathematical operations on each set (e.g., based on a dictionary of terms) to compute information measures contained in the respective sets, performing mathematical computations on the measures to produce results indicating a measure of similarity between the sets. The comparison technique may involve computing total numbers of terms, frequencies of occurrences of each term, etc. U.S. Pat. No. 8,799,339, entitled “Device For and Method of Measuring Similarity Between Sets,” the entirety of which is incorporated herein by this reference, describes example processes for comparing sets that may, but need not, be utilized in implementations disclosed herein.

Some implementations disclosed herein measure similarity between sets, which can be used to determine how closely an AI-generated response matches a verified set of facts or rules. The techniques disclosed herein may be used, for example, to identify discrepancies or “hallucinations” in the outputs of LLMs and other Gen AI models, and filter them out to ensure accuracy and reliability. Some implementations measure similarity to compare LLM outputs with a database of accurate information. By doing so, the system can (a) verify the factual accuracy of AI-generated responses; (b) assign a similarity score to each response based on how closely it matches the verified data; and/or (c) filter out or flag responses that do not meet the required accuracy threshold, ensuring that only reliable information is provided to the end-user. This approach significantly enhances the trustworthiness of LLM and other Gen AI applications by reducing the risk of misinformation and ensuring that AI-generated content adheres to established standards and facts.

Some implementations involve a system architecture that includes a data repository, a Gen AI interface, a verification module, a filtering mechanism, and a user interface. The data repository may be, for example, a database containing accurate data, rule books, SOPs, and other verified information relevant to the application domain. A Gen AI interface may be, for example, an interface that allows the system to interact with various LLMs, such as GPT-4, BERT, or other proprietary or open models. A verification module may be, for example, a component that compares the LLM output against the data repository to verify its accuracy. A filtering mechanism may be, for example, a process that filters out or flags responses that do not meet the accuracy criteria. A user interface may provide, for example, a dashboard or other interface for users to review flagged responses, adjust settings, and monitor system performance.

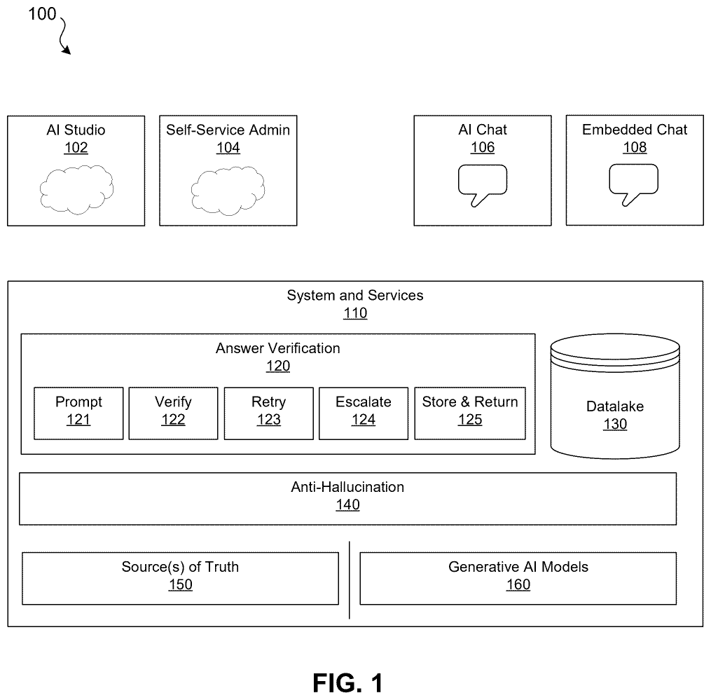

FIG. 1 is a block diagram illustrating exemplary system components of a system 100 configured to assess, identify, filter, or otherwise address hallucinations or other inaccuracies in Gen AI output. The AI Studio component 102 provides various products and offerings made available from a service provider (e.g., software-as-a-service (SAAS) applications made available to customers implementing the services). The AI Chat component 106 provides a chat interface that may have been developed by the AI Studio service provider and/or hosted within the AI studio component 102. The embedded chat component 108 provides a chat interface that may have been developed by the AI studio service provider and licensed and embedded within another party's (e.g., a customer brand's) websites and/or applications. The self-service admin component 104 may enable customers to configure services (e.g., SaaS customer self-service administration of features such as similarity thresholds to be used for answer verification, responsive action to inaccuracy, escalation procedures, etc.)

The systems and services 110 include an answer verification component 110, a data lake 130, an anti-hallucination component 140, a source of truth 150, and Generative AI models 160. The systems and services may include or utilize functions (e.g., APIs) that are created and/or managed by the AI studio service provider. The functions (e.g., APIs) may be used to interface with the answer verification component 110.

The data lake 130 may provide a centralized system that stores, processes, and secures large amounts of data. The data lake 130 may store data in its original format, regardless of its structure. The data lake 130 may obtain data via a data ingestion process that involves collecting data from various sources, such as streaming data, batch data, and internal and external data. The data lake 130 may store and or process the collected data in its native format, such as files or object blobs. The data lake 130 may be hosted via a cloud-based storage infrastructure. The data lake 130 may provide a centralized data storage system specifically designed to hold and analyze large volumes of data, allowing a Security Operations Center (SOC) to gain comprehensive visibility into their network and systems, enabling faster threat detection and incident response through advanced analytics capabilities. The data lake 130 may provide a secure SOC/2 cloud storage for the AI studio provider and/or its customer's proprietary data (e.g., proprietary brand data).

The answer verification component 120 provides processes (e.g., an algorithmic solution) for assessing output of Generative AI models 160, e.g., determining if a response generated by a Gen AI model is free of hallucinations, or within customer defined similarity thresholds.

The prompts block 121 provide a question or other prompt that aims to derive factual answers, trends, analysis, or insights from a customer's (e.g., brand's) proprietary data.

The verify block 122 provides a verification process that evaluates the similarity, or accuracy, of a generated response from one of the Gen AI models 160 and the actual factual information as defined by the customer (e.g., brand) in their sources of truth 150.

The retry block 123 initiates a retry process. Answers to prompts that are deemed inaccurate or hallucinatory are retried with additional instructions and guidance to improve the Gen AI accuracy.

The escalate block 124 initiates an escalation process. Answers that fail (e.g., initially or after one or more retries) to meet quality standards are marked and submitted for escalation with a customer (e.g., brand) representative.

Store and return block 125 initiates a store and return process. Verifiable answers are returned to the user in response to the original prompt. The prompt and answer are further added to the AI studio provider's proprietary model to further refine and improve the accuracy of the system.

The anti-hallucination component 140 provides processes used to score document set similarity between sources of truth 150 and answers provided by the Gen AI models 160.

The sources of truth 150 include may customer (e.g., brand) proprietary data, customer manuals and materials, brand FAQs, SOPs, and rule sets, and other data sources. The customer/brand propriety data may include any proprietary data owned by a brand from which insights can be derived. The brand manuals and materials can include technical documentation and materials related to an brand promise and strategic direction. Brand FAQs, SOPs, and rule sets can include digitized product or service FAQs, standard operating procedure for business processes, or rule sets. The other data source may include, but are not limited to, databases, APIs, ledgers, etc. that contain brand proprietary information.

The Gen AI models 160 may include (or access) models such as ChatGPT®, Gemini®, Anthropic®, and the like. The AI studio service provider may implement processes that leverage these models to derive insights. The Gen AI models may additionally or alternatively include models, RAGs, and/or other proprietary systems provided by the AI studio service provider, e.g., a model and RAG system that combines the AI studio service provider's proprietary brand insights along with customer brand proprietary data.

Some implementations disclosed herein involve methods or systems that include various processing components. Such component processes may include, but are not limited to including, input processing, response generation, verification, scoring, filtering, and/or feedback. Input processing may involve, for example, receiving a user prompt intended for the Gen AI (e.g., LLM). The response generation may involve, for example, the Gen AI generating a response based on the given prompt and/or additional context-specific information. The verification may involve, for example, comparing the generated response against the data repository. This comparison may involve checking factual accuracy, context relevance, adherence to predefined rules or procedures, and other analysis. The scoring may involve, for example, scoring each response based on its accuracy and adherence to the reference data. A threshold score may be used to determine how a response is treated, e.g., whether the response is accepted, flagged, or rejected, as examples. The filtering may involve filtering responses below the accuracy threshold, or flagging such responses for further review. Accepted responses are returned to the user. The feedback may involve flagging responses for review by human experts. The feedback may be used to update and improve the data repository and verification algorithms.’

The techniques described herein for identifying, filtering, and/or otherwise addressing hallucinations or other inaccuracies in Gen AI output may be used in a variety of applications. Such applications include, but are not limited to, brand monitoring, customer service, military operations, education and training, and healthcare. An exemplary brand monitoring application may ensure that LLM-generated content about a brand is accurate and free from misinformation, thus protecting the brand's reputation. An exemplary customer service application may involve verifying the accuracy of responses provided by AI-powered customer service chatbots, enhancing customer trust and satisfaction. An exemplary military operations application may involve ensuring that AI systems used in military contexts produce outputs that adhere to established SOPs and are factually correct. An exemplary education and training application may involve applying verification to AI tutors and training systems, ensuring the information provided is accurate and reliable. An exemplary healthcare application may involve verifying AI-generated medical advice and information, reducing the risk of misinformation in critical healthcare applications.

The following describes a brand monitoring application to illustrate advantages of certain aspects of the certain techniques disclosed herein. In this example, a brand monitoring tool integrates a verification process to verify LLM output. When the LLM generates a response about the brand's product, a verification module checks this response against the company's verified product data and marketing materials stored in the data repository. If the response includes incorrect information or deviates from the brand's message, it is flagged for review by the brand's marketing team.

Techniques disclosed herein can provide various advantages including, but not limited to, increasing reliability, versatility, user trust, and accuracy/performance improvements. Increased reliability may involve enhancing the reliability and trustworthiness of AI-generated content by filtering out hallucinations. Versatility may be facilitated across various domains in which factual accuracy is a priority. User trust may involve building user trust in AI systems by ensuring the accuracy of the information provided. Continuous Improvement may be facilitated via a feedback loop that allows continuous improvement of the system's accuracy and performance.

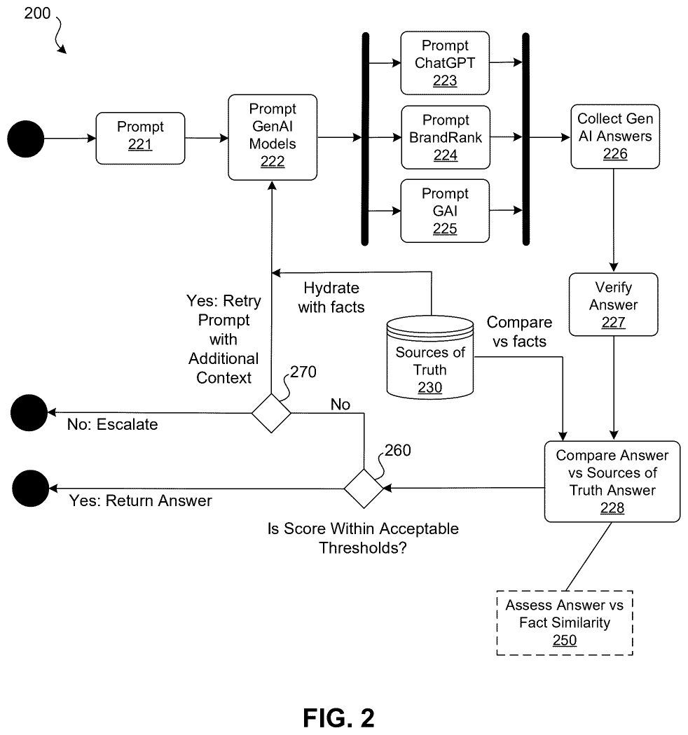

FIG. 2 is a block diagram 200 illustrating an exemplary method to assess, identify, filter, or otherwise address hallucinations or other inaccuracies in Gen AI output. In this example, input is provided at prompt block 221 (e.g., a user may enter a text query such as “how many days of paternity leave do I get as a 10^{th} year employee”) and used at prompt Gen AI models block 222 (potentially along with information from sources of truth 230). The information is used to prompt one or more Gen AI processes. In this specific example, the information is provided to prompt ChatGPT at prompt ChatGPT block 223, to prompt a propriety service provider model at prompt Brandrank block 224, and to prompt another Gen AI at prompt GAI block 225. The Gen AI answers are collected at collect Gen AI answers block 226. The collected answers are then assessed at verify answer block 227. At block 228, the answers are compared versus the sources of truth 230 (or a subset of the data therefrom). The answers may be assessed versus fact similarity at block 250. One or more scores (e.g., an answer verification score, etc.) may be determined via blocks 228 and/or 250. Decision block 260 assesses whether a score (e.g., an answer verification score, etc.) for an answer is within an acceptable threshold. If the score is within the acceptable threshold, then then the answer is returned (e.g., provided to the user via a user interface). If not, then decision block 270 determines whether to retry the answer generation and verification process again. If block 270 determines to retry, then a retry prompt is generated with additional context (from sources of truth 230 and/or elsewhere) and used to prompt the Gen AI models at block 222. If block 270 determines to not retry, then escalation is initiated, e.g., notifying a human reviewer to review the inaccuracy to provide a better response to the requester, update the sources of truth to ensure more accurate future responses to similar questions, and/or to perform other appropriate actions.

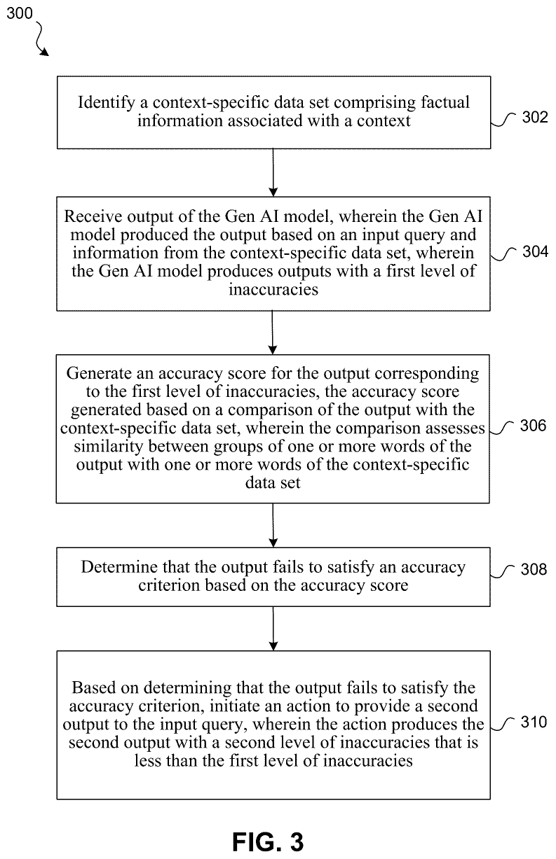

FIG. 3 is a block diagram illustrating an exemplary method 300 to assess, identify, filter, or otherwise address hallucinations or other inaccuracies in Gen AI output. In some implementations, the method 300 is performed by a device, such as a mobile device, desktop, laptop, or server device. In some implementations, the method 300 is performed by processing logic, including hardware, firmware, software, or a combination thereof. In some implementations, the method 300 is performed by a processor executing code stored in a non-transitory computer-readable medium (e.g., a memory). Each of the blocks in the method 300 may be enabled and executed in any order.

At block 302, the method 300 involves identifying a context-specific data set comprising factual information associated with a context. The context may be specific to an organization or agency, a group or topic within an organization's or agency's knowledge set, and/or a specific query initiated for the Gen AI model. In one example, an organization provides a service through which employes ask questions about the organization. For example, an employee might use the service to ask about a daily portion of expenses that can be taken for meals as the employee travels. The organization may include a documents and other data that includes a large volume of information that may be relevant to its employees, including a document that provides a large (e.g., 150 page handbook for employees) that identifies that a meal allowance for traveling employees is $50/day. In this example, the context-specific data set may be this limited set of information (e.g., the set of all employee information, the particular document, etc.). The system may be configured to use various criteria to identify an appropriate context-specific data set. Such a data set may be used to guide a Gen AI (e.g., via a RAG implementation) and/or for verification of the Gen AI's output. The data set may be updated over time, e.g., such that it includes the most current version of the employee handbook, etc. The dataset may depend upon the domain (e.g., the particular organization, agency, etc., topic of the chatbot, portal, interface, etc., and/or the particular inquiry made by a user, e.g., travel policy versus company history versus physical office space information). The context-specific data set is generally selected to be narrower than the broader set of information upon which a Gen AI may have been trained on or that otherwise might be available. This focus may increase the reliability of the Gen AI output and/or facilitate a more reliable accuracy verification process.

At block 304, the method 300 involves receiving output of the Gen AI model, wherein the Gen AI model produced the output based on an input query and information from the context-specific data set, wherein the Gen AI model produces outputs that include a first level of inaccuracies. The Gen AI may be configured (e.g., based on the input that is provided to it) to provide responses using a limited universe of information, e.g., using the context-specific data set or an identified portion thereof. In one example, based on a query associated with employee policy, the system identifies a limited set of the organizations document that are relevant to that topic, e.g., the 50 documents that relate to employee policy.

The Gen AI may be a model that was trained on information applicable to many domains, e.g., using generally available Internet information. In some implementations, the Gen AI may receive additional information (e.g., a separate set of information related to specific context converted to a representation stored in a vector database). When a query is entered, the system may first reference find contextually relevant info to provide to the Gen AI, e.g., via retrieval-augmentation generation (RAG) process. Even with such guidance with context information the Gen AI outputs may have an unacceptably high level of inaccuracy, e.g., a 15% hallucination/inaccuracy level.

At block 306, the method 300 involves generating an accuracy score for the output of the Gen AI based on a comparison of the output with the context-specific data set, wherein the comparison assesses similarity between groups of one or more words of the output with one or more words of the context-specific data set. The comparison may involve identifying relevant portions of the context-specific data set to compare against the output. Such portions may be identified via the Gen AI, a separate process, or both. The identification of relevant sub-portions may involve interpreting the query and identifying a limited amount (e.g., 5 pages, 3 paragraphs, etc.) in the sources of truth. The output may be compared (as a whole or in parts) against the identified portions of the Gen AI output.

The comparison may attempt to determine whether the response accurately represents the information available in that source of information. This comparison process may account for output information including multiple pieces of information and/or differences in expression (e.g., that similar or the same concepts may be expressed using different words and phrases). The comparison may involve sequence matching of characters, words, phrases, tokens, etc. in comparison data sets.

Some implementations utilize a set comparison technique to determine a measure of similarity between sets (e.g., a set corresponding to a Gen AI output and a set corresponding to a source of truth dataset or portion thereof). A comparison process may involve identifying the sets for comparison, calculating a union of the sets (e.g., a mathematical union based upon set theory or a concatenation of the sets), performing non-linear mathematical operations on each set (e.g., based on a dictionary of terms) to compute information measures contained in the respective sets, performing mathematical computations on the measures to produce results indicating a measure of similarity between the sets. The comparison technique may involve computing total numbers of terms, frequencies of occurrences of each term, etc.

At block 308, the method 300 involves determining that the output fails to satisfy an accuracy criterion based on the accuracy score. This may involve comparison against a threshold, e.g., a numerical threshold.

At block 310, the method 300 involves, based on determining that the output fails to satisfy the accuracy criterion, initiating an action to provide a second output to the input query, wherein the action produces outputs that on average include a second level of inaccuracies that is less than the first level of inaccuracies. In some implementations, the Gen AI query may be reinitiated with additional information (potentially based on asking the user for more information). This may occur iteratively until an acceptable accuracy level is achieved. If an acceptable accuracy level is not achieved after a number of attempts, an alternative approach may be initiated. In some implementations, a query is flagged for human review, e.g., so that a human can respond to the inquiry and/or supplement the data set so that the data set includes information sufficient to answer the query when it is asked in the future. For example, the system may provide an organization with a list of the top questions that are asked for which a sufficiently accurate answer is not produced by the system so that the organization can update its documentation for future queries.

Some implementations perform additional analysis to attempt to determine whether an output (even if accurate) also is response to the user's query, e.g., does it really answer the user's question. This may involve comparing the output with the written words of the context-specific data set (i.e., the source of truth) and/or account for different words and phrases having the same or similar meanings. It may utilize a fuzzy process. Such a process may apply algorithmic intelligence so that the system is able to achieve conceptual matching rather than just semantic matching. A fuzzy process may account for the context of the inquiry and/or additional features to provide a more logic-based confidence score. A similarity score may be determined based on mathematics (e.g., showing how similar they are) and a confidence score may be based on logic (e.g., showing how well the output responds to the input query). Having both may provide more informative and efficient evaluation of Gen AI outputs.

Fuzzy logic may be applied to parse an inquiry and extract features that are then evaluated via a set of rules (e.g., if/then logic) to assess confidence level. Fuzzy logic may be adapted, e.g., with rules emerging as a system is built and tested to account for the nuances of language and identify misunderstandings and irrelevancies.

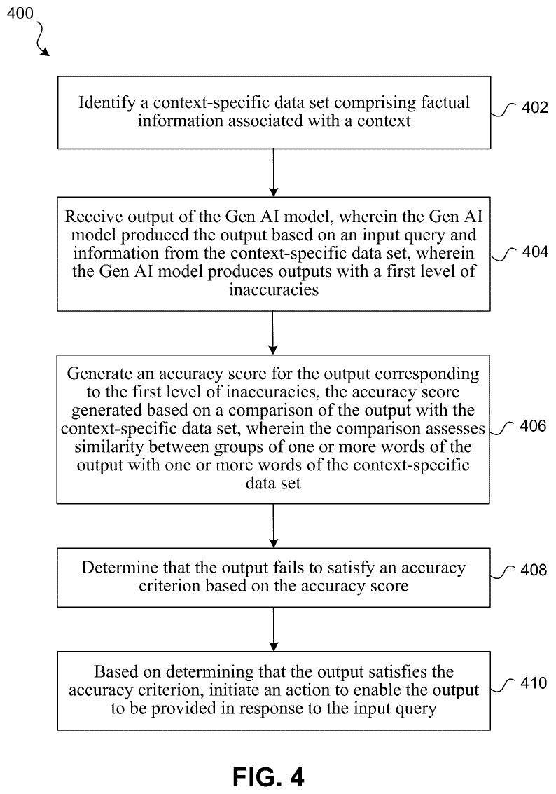

FIG. 4 is a block diagram illustrating an exemplary method 400 to assess, identify, filter, or otherwise address hallucinations or other inaccuracies in Gen AI output. In some implementations, the method 400 is performed by a device, such as a mobile device, desktop, laptop, or server device. In some implementations, the method 400 is performed by processing logic, including hardware, firmware, software, or a combination thereof. In some implementations, the method 400 is performed by a processor executing code stored in a non-transitory computer-readable medium (e.g., a memory). Each of the blocks in the method 400 may be enabled and executed in any order.

Blocks 402, 404, and 406 of FIG. 4 correspond to operations similar to those described with respect to block 302, 304, and 306, respectively, of FIG. 3. At block 408, the method 400 involves determining that the output satisfies an accuracy criterion based on the accuracy score. This may involve comparison against a threshold, e.g., a numerical threshold. At block 410, based on determining that the output satisfies the accuracy criterion, the method 400 involves initiating an action to enable the output to be provided in response to the input query. For example, the output may be presented to the user who submitted the prompt via chat or other user interface.

Example Use Case: Company A AI Chatbot with Answer Verification

The following example illustrates an application of an Answer Verification Filter. Consider the case of a customer interacting with a conversational AI chatbot on the website of company A. In this example, company A is a popular online clothing retailer that has implemented a generative AI-powered chatbot to handle customer inquiries. This chatbot is trained to answer questions based on A's customer service documents, including its official return policy.

Step 1: Customer Inquiry. A customer, John, recently purchased a pair of shoes from A but realizes they do not fit. He visits the A website and engages with the chatbot. He types the following prompt: “How do I return the shoes I just bought that don't fit?”

Step 2: Initial AI Response. The generative AI model powering the chatbot retrieves stored knowledge from its training data and provides an answer based on its understanding of A's return policy. Example AI response: “You can return your shoes within 60 days of purchase by visiting a store or shipping them back using a prepaid return label.”

Step 3: Answer Verification Filter Engages. Before presenting the answer to the customer, the Answer Verification Filter enters the process. The filter cross-references the AI's response with the source of truth, which in this case is the actual A's return policy document. The return policy states:

### Company A Return Policy:

“Customers may return unworn items in their original packaging within 30 days of purchase for a full refund. Returns can be made at A retail stores or by requesting a prepaid return shipping label via our online portal.”

Step 4: Accuracy Scoring. The Answer Verification Filter compares the AI-generated response with the source of truth and assigns an accuracy score based on similarity. Using a set-based comparison technique, the system determines how closely the AI's response matches the official return policy, producing output that identifies:
The AI response incorrectly states a 60-day return window when the actual return window is 30 days.
The response accurately mentions both store returns and prepaid return labels.
However, the AI response does not clarify that items must be unworn and in original packaging.

After analyzing the discrepancies, the Answer Verification Filter assigns a score of 87 out of 100, which falls below the acceptable threshold (95 or higher).

Step 5: System Determines the Next Action. Since the AI response fails verification, the chatbot does not immediately present the answer to the customer. Instead, the system follows predefined rules set in the control panel, which determine alternative responses for low-scoring answers. Possible corrective actions include:
1. Displaying the Correct Answer: The chatbot retrieves the verified policy text and presents it instead of the AI-generated answer.
2. Providing a Reference Link: The chatbot links directly to the A return policy page.
3. Connecting to Customer Service: The chatbot provides a phone number or email for further assistance.

For this case, the system is configured to display the corrected response:

### Verified Answer:

“Company A accepts returns for unworn items in original packaging within 30 days of purchase. You can return them at an Company A store or request a prepaid shipping label from our online portal. For full details, visit our return policy page: [link].”

Step 6: Preventing Hallucination Risks. This approach ensures that LLM-generated responses do not deviate from the verified company policy, preventing misinformation.

AI-generated chatbot errors have led to serious reputational damage and legal issues for companies, with notable cases for various companies. One such company faced liability after an AI chatbot provided misleading refund information. By implementing the techniques disclose herein, Answer Verification Filter, company A can confidently use generative AI without the risk of customers receiving inaccurate or misleading information.

The Answer Verification Filter and other techniques disclosed herein may involve a set-based comparison technique to measure the similarity between the AI-generated response and the verified source of truth. This technique may include: (1) Tokenization and Preprocessing; (2) Vector Representation; and/or (3) Set Similarity Computation.

Tokenization and Preprocessing. Both the AI response and the source of truth may be tokenized into words and phrases. Stopwords (e.g., “the,” “of,” “and”) may be removed. Lemmatization may be performed to normalize words (e.g., “returns”→“return”).

Vector Representation. The processed text from both sources may be converted into mathematical vectors using an embedding model (e.g., TF-IDF, Word2Vec, BERT embeddings). A high-dimensional representation of the AI response and source document may be created.

Set Similarity Computation. The system may apply multiple similarity metrics to compare the AI response and the reference text using measurement tools such as:
1. Jaccard Similarity
   Measures the overlap between unique words in both sets:

$$J ( A , B ) = \vert A ⋂ B \vert \vert A ⋃ B \vert J ( A , B ) = \backslash frac \{ \vert A \backslash cap B \vert \} \{ \vert A \backslash cup B \vert \} J ( A , B ) = \vert A ⋃ B \vert \vert A ⋂ B \vert$$

where:
AAA=words in AI response
BBB=words in return policy
2. Cosine Similarity
   Computes similarity based on vectorized word embeddings:

$$cos ( θ ) = VA \cdot VB ‖ VA ‖ ‖ VB ‖ \backslash cos ( \backslash theta ) = \backslash frac \{ V\_A \backslash cdot V\_B \} \{ ‖ V\_A ‖ ‖ V\_B ‖ \} cos ( θ ) = ‖ VA ‖ ‖ VB ‖ VA \cdot VB$$

where VAV_AVA and VBV_BVB are vector representations of the AI response and the reference text.
3. Semantic Similarity Score.
   This may involve using the one or more of the techniques described in U.S. Pat. No. 8,799,339, entitled “Device For and Method of Measuring Similarity Between Sets,” the entirety of which is incorporated herein by this reference. This may involve using other techniques such as a pre-trained language model (such as BERT/ROBERTa) to evaluate conceptual similarity, beyond exact word matches.
4. Weighted Term Importance.
   Key terms (e.g., “30 days”, “original packaging”, “unworn items”) are assigned higher weights.
   Differences in critical terms significantly impact the similarity score.

Step 5: Accuracy Score Assignment. For illustrative purposes, after computing the similarity scores, the system may assign an overall accuracy score (e.g., on a 1-100 scale):

| Metric | Weight | Score Contribution |
|---|---|---|
| Jaccard Similarity | 20% | 18/20 |
| Cosine Similarity | 25% | 21/25 |
| Semantic Similarity | 30% | 26/30 |
| Weighted Term Matching | 25% | 22/25 |
| Final Accuracy Score | 100% | 87/100 |

Since 87<95 (the verification threshold), the response is flagged as inaccurate and is not displayed to the user.

### Additional Advantages of Certain Implementations

The Answer Verification Filter and other processes and techniques disclosed herein provide technical improvements to the operation of AI-driven systems. For example, implementing one or more of the techniques disclosed herein may introduce real-time accuracy scoring and verification mechanisms that enhance response reliability, computational efficiency, and resource optimization. Unlike conventional AI models that rely solely on their trained knowledge to generate responses, techniques disclosed herein may be used to dynamically verify outputs against a known source of truth, reducing hallucinations and/or increasing factual consistency. This additional layer of processing introduces a concrete, technological advancement that improves AI response mechanisms without increasing computational load beyond feasible limits.

Enhancing Accuracy While Reducing Errors. Traditional AI chatbots and generative AI models are known to produce hallucinations, where answers may sound plausible but deviate from the actual source of truth. One or more of the systems and techniques disclosed herein may be used to systematically evaluate and score AI-generated outputs, ensuring that only high-confidence, factually accurate responses reach the end user. This accuracy assessment process is a fundamental technical advancement, addressing a core flaw in AI chatbot deployment.

In some implementations, the system leverages a set-based comparison technique that goes beyond simple keyword matching. By incorporating vector-based semantic similarity computations, it identifies discrepancies at a conceptual level, allowing for the detection of subtle misinterpretations or misleading AI hallucinations. This prevents incorrect responses from being presented, thereby increasing system reliability and reducing user frustration.

Various improvements over existing systems may be achieved. These improvements include, but are not limited to improvements to baseline AI Systems. Baseline AI systems provide responses without real-time accuracy verification, leading to an estimated 10-20% hallucination rate in open-ended chatbot applications. In contrast, utilizing one or more of the techniques disclosed herein for verification, AI-generated responses may undergo accuracy scoring, reducing incorrect responses to under 1%, significantly improving response reliability. This direct reduction in erroneous output constitutes a clear technological advantage over conventional AI systems, making the chatbot more useful, accurate, and aligned with enterprise applications that demand factual correctness. Consequently, such systems may be able to provide accurate results more quickly than otherwise.

Computational Efficiency and Power Optimization. Unlike approaches that require continuous model retraining to improve AI accuracy, one or more of the systems and techniques disclosed herein may be utilized to achieve improved response accuracy without significantly increasing power consumption or data storage demands. Traditional AI models require periodic retraining, which involves expensive GPU-intensive computations. Training a large-scale AI model with updated data consumes thousands of kilowatt-hours per training cycle, making it cost-prohibitive for real-time adjustments. One or more of the systems and techniques disclosed herein may enable dynamic accuracy filtering without retraining the base AI model, thus reducing computational overhead while maintaining system performance. Instead of feeding more data into AI models in an attempt to reduce errors, a verification system prevents incorrect responses before they reach users, significantly improving energy efficiency.

Example power efficiency gain. An unfiltered AI Chatbot may involve processing millions of user queries per day, requiring continuous LLM inference, resulting in high GPU usage. In contrast, a system that utilizes one or more of the techniques disclosed herein may be considered verification enabled. By verifying answers before presentation, such system have demonstrated the ability to achieve a 10-20% reduction in unnecessary AI inference cycles, lowering computational demands and reducing server load. This is a tangible improvement to computer system operation, as it optimizes AI inference efficiency without sacrificing accuracy, thereby enhancing system scalability.

Faster Response Time Without Sacrificing Quality. A naive implementation of answer verification could introduce latency by requiring post-processing before response delivery. However, one or more of the implementations disclosed herein are well-suited for low-latency verification, leveraging a parallelized scoring engine that operates within milliseconds of AI response generation. Existing AI Models may involve generating responses in 500-700 ms for standard chatbot interactions, but fail to verify accuracy in real-time. Utilization of one or more of the techniques disclosed herein for answer verification, in contrast, may involve introducing a sub-500 ms verification step, ensuring that AI responses remain under 1000 ms total while being filtered for accuracy. One or more of the systems and techniques disclosed herein may achieve this by using optimized indexing structures and/or precomputed embeddings that minimize computational complexity. Unlike traditional brute-force document comparisons, which could take seconds per query, such techniques may employ a probabilistic similarity matching technique, ensuring real-time validation without significant computational overhead. This represents a direct technical enhancement that allows AI chatbots to deliver more accurate responses without delaying user interactions, making the system both faster and more precise.

Reduction in Bandwidth and Data Storage Requirements. The systems and techniques disclosed herein may also contribute to more efficient network operations by reducing the need for excessive API calls, redundant data transfers, and unnecessary cloud storage utilization. Traditional systems may require users to manually verify AI-generated responses, often leading to repeat queries, increased server traffic, and redundant API calls. In contrast, one or more of the implementations disclosed herein may prevent incorrect responses from being shown, which meaningfully reduces re-query rates, optimizing overall data traffic. By ensuring AI outputs are factually correct on the first attempt, the system minimizes unnecessary data transmission, reducing both cloud storage requirements and network bandwidth consumption.

The systems and techniques disclosed herein may provide a tangible improvement in the operation of computing devices by:
1. Reducing AI hallucinations through a real-time answer verification process.
2. Minimizing unnecessary AI inference cycles, thereby improving computational efficiency.
3. Enhancing response speed using optimized similarity scoring techniques.
4. Lowering power consumption by avoiding unnecessary model retraining.
5. Reducing bandwidth and storage requirements by preventing redundant queries.

This is not merely an abstract concept but a practical and technical enhancement to existing AI chatbot and generative AI architectures, ensuring that they operate faster, more accurately, and with greater computational efficiency. Given that AI hallucinations are a well-documented technical problem, the Answer Verification system and other techniques disclosed herein may directly address this deficiency by introducing a concrete verification mechanism. This represents an advancement in AI-driven customer interaction technology, making it a specific and measurable improvement to computer operations.

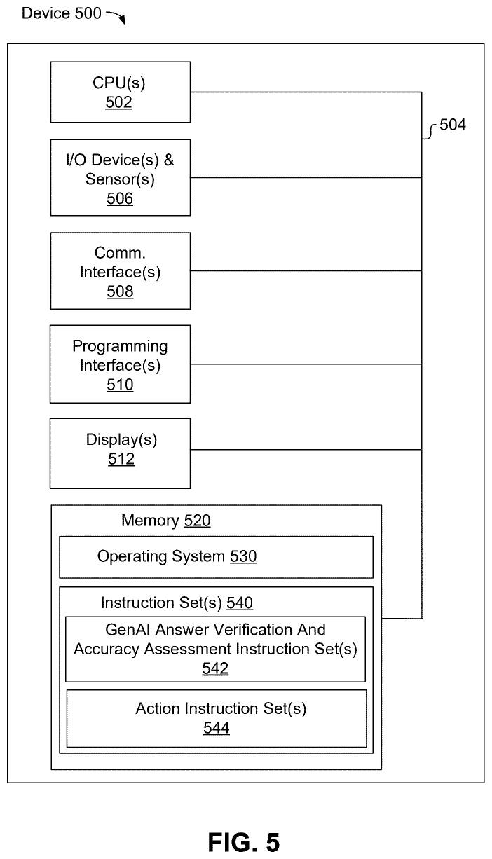

FIG. 5 is a block diagram of an example device 500. Device 500 illustrates an exemplary device configuration. While certain specific features are illustrated, those skilled in the art will appreciate from the present disclosure that various other features have not been illustrated for the sake of brevity, and so as not to obscure more pertinent aspects of the implementations disclosed herein. To that end, as a non-limiting example, in some implementations the device 500 includes one or more processing units 502 (e.g., microprocessors, ASICs, FPGAs, GPUs, CPUs, processing cores, and/or the like), one or more input/output (I/O) devices and sensors 506, one or more communication interfaces 508 (e.g., USB, FIREWIRE, THUNDERBOLT, IEEE 802.3x, IEEE 802.11x, IEEE 802.14x, GSM, CDMA, TDMA, GPS, IR, BLUETOOTH, ZIGBEE, SPI, I2C, and/or the like type interface), one or more programming (e.g., I/O) interfaces 510, output devices (e.g., one or more displays) 512, a memory 520, and one or more communication buses 504 for interconnecting these and various other components.

In some implementations, the one or more communication buses 504 include circuitry that interconnects and controls communications between system components.

In some implementations, the one or more displays 512 correspond to holographic, digital light processing (DLP), liquid-crystal display (LCD), liquid-crystal on silicon (LCoS), organic light-emitting field-effect transitory (OLET), organic light-emitting diode (OLED), surface-conduction electron-emitter display (SED), field-emission display (FED), quantum-dot light-emitting diode (QD-LED), micro-electromechanical system (MEMS), and/or the like display types.

The memory 520 includes high-speed random-access memory, such as DRAM, SRAM, DDR RAM, or other random-access solid-state memory devices. In some implementations, the memory 520 includes non-volatile memory, such as one or more magnetic disk storage devices, optical disk storage devices, flash memory devices, or other non-volatile solid-state storage devices. The memory 520 optionally includes one or more storage devices remotely located from the one or more processing units 502. The memory 520 includes a non-transitory computer readable storage medium.

In some implementations, the memory 520 or the non-transitory computer readable storage medium of the memory 520 stores an optional operating system 530 and one or more instruction set(s) 550. The operating system 530 includes procedures for handling various basic system services and for performing hardware dependent tasks. In some implementations, the instruction set(s) 540 include executable software defined by binary information stored in the form of electrical charge. In some implementations, the instruction set(s) 540 are software that is executable by the one or more processing units 502 to carry out one or more of the techniques described herein.

The instruction set(s) 540 includes Gen AI Answer Verification and Accuracy Assessment instruction set 542 (configured to perform verification and accuracy assessments as described herein) and an action instruction set 544 (configured to take action based on verification and accuracy assessments as described herein). The instruction set(s) 540 may be embodied as a single software executable or multiple software executables.

Although the instruction set(s) 540 are shown as residing on a single device, it should be understood that in other implementations, any combination of the elements may be located in separate computing devices. Moreover, FIG. 5 is intended more as functional description of the various features which are present in a particular implementation as opposed to a structural schematic of the implementations described herein. As recognized by those of ordinary skill in the art, items shown separately could be combined and some items could be separated. The actual number of instructions sets and how features are allocated among them may vary from one implementation to another and may depend in part on the particular combination of hardware, software, and/or firmware chosen for a particular implementation.

Those of ordinary skill in the art will appreciate that well-known systems, methods, components, devices, and circuits have not been described in exhaustive detail so as not to obscure more pertinent aspects of the example implementations described herein. Moreover, other effective aspects and/or variants do not include all of the specific details described herein. Thus, several details are described in order to provide a thorough understanding of the example aspects as shown in the drawings. Moreover, the drawings merely show some example embodiments of the present disclosure and are therefore not to be considered limiting.

While this specification contains many specific implementation details, these should not be construed as limitations on the scope of any inventions or of what may be claimed, but rather as descriptions of features specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

Embodiments of the subject matter and the operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer programs, e.g., one or more modules of computer program instructions, encoded on computer storage medium for execution by, or to control the operation of, data processing apparatus. Alternatively, or additionally, the program instructions can be encoded on an artificially generated propagated signal, e.g., a machine-generated electrical, optical, or electromagnetic signal, that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially generated propagated signal. The computer storage medium can also be, or be included in, one or more separate physical components or media (e.g., multiple CDs, disks, or other storage devices).

The term “data processing apparatus” encompasses all kinds of apparatus, devices, and machines for processing data, including by way of example a programmable processor, a computer, a system on a chip, or multiple ones, or combinations, of the foregoing. The apparatus can include special purpose logic circuitry, e.g., an FPGA (field programmable gate array) or an ASIC (application specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures. Unless specifically stated otherwise, it is appreciated that throughout this specification discussions utilizing the terms such as “processing,” “computing,” “calculating,” “determining,” and “identifying” or the like refer to actions or processes of a computing device, such as one or more computers or a similar electronic computing device or devices, that manipulate or transform data represented as physical electronic or magnetic quantities within memories, registers, or other information storage devices, transmission devices, or display devices of the computing platform.

The system or systems discussed herein are not limited to any particular hardware architecture or configuration. A computing device can include any suitable arrangement of components that provides a result conditioned on one or more inputs. Suitable computing devices include multipurpose microprocessor-based computer systems accessing stored software that programs or configures the computing system from a general purpose computing apparatus to a specialized computing apparatus implementing one or more implementations of the present subject matter. Any suitable programming, scripting, or other type of language or combinations of languages may be used to implement the teachings contained herein in software to be used in programming or configuring a computing device.

Implementations of the methods disclosed herein may be performed in the operation of such computing devices. The order of the blocks presented in the examples above can be varied for example, blocks can be re-ordered, combined, and/or broken into sub-blocks. Certain blocks or processes can be performed in parallel. The operations described in this specification can be implemented as operations performed by a data processing apparatus on data stored on one or more computer-readable storage devices or received from other sources.

The use of “adapted to” or “configured to” herein is meant as open and inclusive language that does not foreclose devices adapted to or configured to perform additional tasks or steps. Additionally, the use of “based on” is meant to be open and inclusive, in that a process, step, calculation, or other action “based on” one or more recited conditions or values may, in practice, be based on additional conditions or value beyond those recited. Headings, lists, and numbering included herein are for ease of explanation only and are not meant to be limiting.

It will also be understood that, although the terms “first,” “second,” etc. may be used herein to describe various elements, these elements should not be limited by these terms. These terms are only used to distinguish one element from another. For example, a first node could be termed a second node, and, similarly, a second node could be termed a first node, which changing the meaning of the description, so long as all occurrences of the “first node” are renamed consistently and all occurrences of the “second node” are renamed consistently. The first node and the second node are both nodes, but they are not the same node.

The terminology used herein is for the purpose of describing particular implementations only and is not intended to be limiting of the claims. As used in the description of the implementations and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” may be construed to mean “when” or “upon” or “in response to determining” or “in accordance with a determination” or “in response to detecting,” that a stated condition precedent is true, depending on the context. Similarly, the phrase “if it is determined [that a stated condition precedent is true]” or “if [a stated condition precedent is true]” or “when [a stated condition precedent is true]” may be construed to mean “upon determining” or “in response to determining” or “in accordance with a determination” or “upon detecting” or “in response to detecting” that the stated condition precedent is true, depending on the context.

The foregoing description and summary of the invention are to be understood as being in every respect illustrative and exemplary, but not restrictive, and the scope of the invention disclosed herein is not to be determined only from the detailed description of illustrative implementations but according to the full breadth permitted by patent laws. It is to be understood that the implementations shown and described herein are only illustrative of the principles of the present invention and that various modification may be implemented by those skilled in the art without departing from the scope and spirit of the invention.

What is claimed is:

1. A computer-implemented method of improving accuracy of generative artificial intelligence (Gen AI) model output, the method comprising:
at an electronic device:
identifying a context-specific data set comprising factual information associated with a context;
receiving output of the Gen AI model, wherein the Gen AI model produced the output based on an input query and information from the context-specific data set, wherein the Gen AI model produces outputs with a first level of inaccuracies;
generating an accuracy score for the output corresponding to the first level of inaccuracies, the accuracy score generated based on a comparison of the output with the context-specific data set, wherein the comparison assesses similarity between groups of one or more words of the output with one or more words of the context-specific data set;
determining that the output fails to satisfy an accuracy criterion based on the accuracy score; and
based on determining that the output fails to satisfy the accuracy criterion, initiating an action to provide a second output to the input query, wherein the action has an action type that produces the second output with a second level of inaccuracies that is less than the first level of inaccuracies.

2. The method of claim 1, wherein the context is a specific business entity and the context-specific data set comprises information about the specific business entity.

3. The method of claim 1, wherein the context is a specific topic and the context-specific data set comprises information about the specific topic from a knowledge set specific to a specific business entity.

4. The method of claim 1, wherein the information from the context-specific data set is provided to the Gen AI model via a retrieval-augmentation generation (RAG) input process.

5. The method of claim 1, wherein the action to provide the second output to the input query comprises determining to not provide the output in response to the input query.

6. The method of claim 1, wherein the action to provide the second output to the input query comprises flagging the output for human review.

7. The method of claim 1, wherein the action to provide the second output to the input query comprises initiating a second input query with different search terms or different information from the context-specific data set.

8. The method of claim 1, wherein the action to provide the second output to the input query comprises initiating a second input query with information determined based on the comparison assessing similarity between groups of the one or more words of the output with the one or more words of the context-specific data set.

9. A computer-implemented method of improving accuracy of generative artificial intelligence (Gen AI) model output, the method comprising:
at an electronic device:
identifying a context-specific data set comprising factual information associated with a context;
receiving output of the Gen AI model, wherein the Gen AI model produced the output based on an input query and information from the context-specific data set, wherein the Gen AI model produces outputs with a first level of inaccuracies;
generating an accuracy score for the output corresponding to the first level of inaccuracies, the accuracy score generated based on a comparison of the output with the context-specific data set, wherein the comparison assesses similarity between groups of one or more words of the output with one or more words of the context-specific data set;
determining that the output satisfies an accuracy criterion based on the accuracy score; and
based on determining that the output satisfies the accuracy criterion, initiating an action to enable the output to be provided in response to the input query.

10. The method of claim 1, wherein the context is a specific business entity and the context-specific data set comprises information about the specific business entity.

11. The method of claim 1, wherein the context is a specific topic and the context-specific data set comprises information about the specific topic from a knowledge set specific to a specific business entity.

12. The method of claim 1, wherein the information from the context-specific data set is provided to the Gen AI model via a retrieval-augmentation generation (RAG) input process.

13. A system comprising:
a non-transitory computer-readable storage medium; and
one or more processors coupled to the non-transitory computer-readable storage medium, wherein the non-transitory computer-readable storage medium comprises program instructions that, when executed on the one or more processors, cause the first device to perform operations comprising:
identifying a context-specific data set comprising factual information associated with a context;
receiving output of the Gen AI model, wherein the Gen AI model produced the output based on an input query and information from the context-specific data set, wherein the Gen AI model produces outputs with a first level of inaccuracies;
generating an accuracy score for the output corresponding to the first level of inaccuracies, the accuracy score generated based on a comparison of the output with the context-specific data set, wherein the comparison assesses similarity between groups of one or more words of the output with one or more words of the context-specific data set;
determining that the output fails to satisfy an accuracy criterion based on the accuracy score; and
based on determining that the output fails to satisfy the accuracy criterion, initiating an action to provide a second output to the input query, wherein the action has an action type that produces the second output with a second level of inaccuracies that is less than the first level of inaccuracies; and
based on determining that the output satisfies the accuracy criterion, initiating an action to enable the output to be provided in response to the input query.

14. The system of claim 13, wherein the context is a specific business entity and the context-specific data set comprises information about the specific business entity.

15. The system of claim 13, wherein the context is a specific topic and the context-specific data set comprises information about the specific topic from a knowledge set specific to a specific business entity.

16. The system of claim 13, wherein the information from the context-specific data set is provided to the Gen AI model via a retrieval-augmentation generation (RAG) input process.

17. The system of claim 13, wherein the action to provide the second output to the input query comprises:
determining to not provide the output in response to the input query;
flagging the output for human review; or
initiating a second input query with different search terms or different information from the context-specific data set.

18. The system of claim 13, wherein the action to provide the second output to the input query comprises initiating a second input query with information determined based on the comparison assessing similarity between groups of the one or more words of the output with the one or more words of the context-specific data set.
